(19) United States
(12) Patent Application Publication
(10) Pub. No.: US 2026/0276439 A1
(43) Pub. Date: Sep. 17, 2026

(54) IDENTIFICATION DEVICE, IDENTIFICATION METHOD, AND COMPUTER-READABLE NON-TRANSITORY STORAGE MEDIA

(71) Applicant: CITIZEN WATCH CO., LTD., Tokyo (JP)

(72) Inventor: Hideki Shimizu, Tokyo (JP)

(73) Assignee: CITIZEN WATCH CO., LTD., Tokyo (JP)

(21) Appl. No.: 19/469,773

(22) PCT Filed: Mar. 28, 2024
(86) PCT No.: PCT/JP2024/012643

§ 371 Date: Sep. 26, 2025

(30) Foreign Application Priority Data
Mar. 31, 2023 (JP) 2023-058737

(51) Int. Cl. G01H 17/00; G08B 21/02

(52) U.S. Cl. CPC G01H 17/00; G08B 21/02

(57) ABSTRACT

An identification device includes a processor configured to acquire information on vibration of a catching part from which a string-shaped object can be suspended, determine, for each of frequency bands, whether a frequency component of the vibration in the frequency band satisfies a predetermined condition, detect whether the vibration is caused by hanging the string-shaped object on the catching part, based on a combination of determination results for the frequency bands, and output a notification based on the result of detection of the cause of the vibration.

### FIELD

The present disclosure relates to an identification device, an identification method, and a computer-readable non-transitory storage media.

### BACKGROUND

There are cases where people hang string-shaped objects on various objects such as hooks or bars, and there is a demand for detecting whether a string-shaped object is caught. In particular, in correctional facilities including detention rooms, since death by strangulation or hanging may occur by hanging a piece of string-form cloth on an iron bar, there is a need to detect such a suicide attempt or related abnormal behavior without using cameras from the perspective of privacy.

Patent Literature 1 describes a detection device that analyzes inaudible sound waves generated in response to human body movement to determine which human body movement has generated the inaudible sound waves. Since airway obstruction generates inaudible sound waves, the detection device described in Patent Literature 1 can detect death by strangulation arising from airway obstruction. On the other hand, death by hanging arising from blood flow obstruction caused by compression of the carotid sinus may not generate inaudible sound waves because it does not necessarily involve airway obstruction; it is therefore difficult for the detection device described in Patent Literature 1 to detect death by hanging.

### CITATION LIST

### Patent Literature

Patent Literature 1: Japanese U.S. Pat. No. 6,779,291

### SUMMARY

As described above, the device described in Patent Literature 1 may not be able to detect a suicide attempt or related abnormal behavior. On the other hand, since a suicide attempt requires hanging a string-shaped object on an iron bar, it will be able to detect a suicide attempt or related abnormal behavior if an act of hanging a string-shaped object can be detected.

The present disclosure aims to provide an identification device, an identification method, and a computer-readable non-transitory storage media that enable detecting an act of hanging a string-shaped object.

### Solution To Problem

An identification device of an embodiment of the present disclosure includes an acquisition unit that acquires information on vibration of a catching part from which a string-shaped object can be suspended; a determination unit that determines, for each of frequency bands, whether a frequency component of the detected vibration in the frequency band satisfies a predetermined condition; a detection unit that detects whether the vibration is caused by hanging the string-shaped object on the catching part, based on a combination of determination results for the frequency bands; and an output unit that outputs a notification based on the result of detection by the detection unit.

The determination unit preferably determines whether frequency components of the vibration in the respective frequency bands exceed a predetermined reference value every predetermined determination period, and counts the number of times the frequency component exceeds the reference value for each frequency band; and the detection unit preferably detects whether the vibration is caused by hanging the string-shaped object on the catching part, based on a combination of counting results for the frequency bands.

The frequency bands are preferably a first band below 0.5 kHz, a second band between 0.5 kHz and 3.0 kHz, and a third band above 3.0 kHz.

The detection unit preferably determines that the vibration is caused by a suicide attempt, when frequency components in the first and third bands exceed a reference value and a frequency component in the second band does not exceed the reference value.

An identification method of an embodiment of the present disclosure is an identification method executed by an identification device, and includes acquiring information on vibration of a catching part from which a string-shaped object can be suspended; determining, for each of frequency bands, whether a frequency component of the detected vibration in the frequency band satisfies a predetermined condition; detecting whether the vibration is caused by hanging the string-shaped object on the catching part, based on a combination of determination results for the frequency bands; and outputting a notification based on the result of detection of the cause of the vibration.

A program of an embodiment of the present disclosure causes a computer to execute a process including acquiring information on vibration of a catching part from which a string-shaped object can be suspended; determining, for each of frequency bands, whether a frequency component of the detected vibration in the frequency band satisfies a predetermined condition; detecting whether the vibration is caused by hanging the string-shaped object on the catching part, based on a combination of determination results for the frequency bands; and outputting a notification based on the result of detection of the cause of the vibration.

### Advantageous Effects of Invention

The identification device, the identification method, and the computer-readable non-transitory storage media of the present disclosure enable detecting an act of hanging a string-shaped object.

### BRIEF DESCRIPTION OF DRAWINGS

FIG. 1 schematically shows an example of the configuration of an identification system of an embodiment.

FIG. 2 is an exemplary functional block diagram of an identification device of the embodiment.

FIGS. 3A-3D are diagrams for explaining examples of vibration of iron bars.

FIG. 4 shows an example of the data structure of a cause table.

FIG. 5 is a flow diagram showing an example of the flow of an identification process.

### DESCRIPTION OF EMBODIMENTS

Various embodiments of the present invention will now be described with reference to the drawings. It should be noted that the technical scope of the present invention is not limited to embodiments thereof, but extends to the inventions described in the claims and their equivalents.

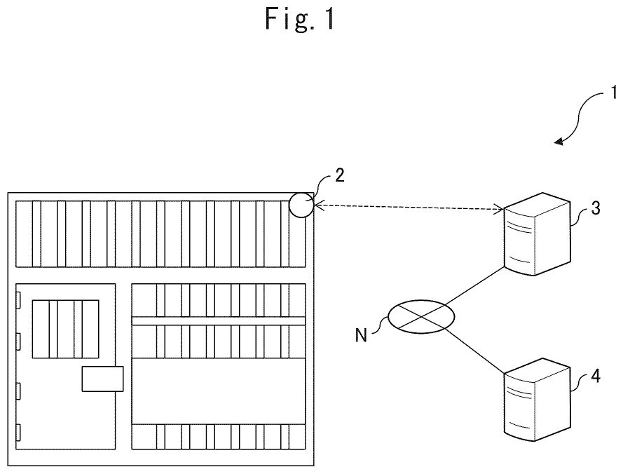

FIG. 1 schematically shows an example of the configuration of an identification system 1 of an embodiment of the present disclosure. The identification system 1 is installed in a facility such as a correctional facility equipped with iron bars. The identification system 1 detects an act of hanging a string-shaped object on an iron bar by identifying the cause of vibration of the iron bars. String-shaped objects include any object that can be used as a string, such as a towel or a piece of clothing, besides a string; however, in the following description, the string-shaped object is assumed to be a towel. The identification system 1 includes a vibration sensor 2, an identification device 3, and a monitoring terminal 4. The identification device 3 and the monitoring terminal 4 are communicably connected to each other via a network N. An iron bar is an example of a catching part from which a string-shaped object can be suspended.

The vibration sensor 2 is disposed on a frame portion of the iron bars and configured to detect vibration of the iron bars, and includes a piezoelectric element and a conversion circuit. The piezoelectric element converts vibration of the iron bars into an analog electrical signal. The conversion circuit applies an amplification process and an A/D conversion process to the analog electrical signal generated by the piezoelectric element to convert it to a time-series digital signal. The conversion circuit may further apply a filtering process to the analog electrical signal or the digital signal to remove a predetermined frequency component. The predetermined frequency component is, for example, a frequency component of 8 kHz or more.

The vibration sensor 2 may be a bone conduction microphone or a contact microphone.

The identification device 3 is a computer such as a server, a personal computer (PC), a tablet terminal, a smartphone, a mobile phone, or a portable game console. Based on vibration of the iron bars detected by the vibration sensor 2, the identification device 3 detects whether the vibration is caused by hanging a towel on an iron bar. The identification device 3 outputs a notification to the monitoring terminal 4, based on the result of detection.

The monitoring terminal 4 is a computer such as a PC, a mobile phone, or a smartphone installed in a monitoring room of the correctional facility or possessed by a watcher. The monitoring terminal 4 notifies the watcher of a notification from the identification device 3 by a voice or an image.

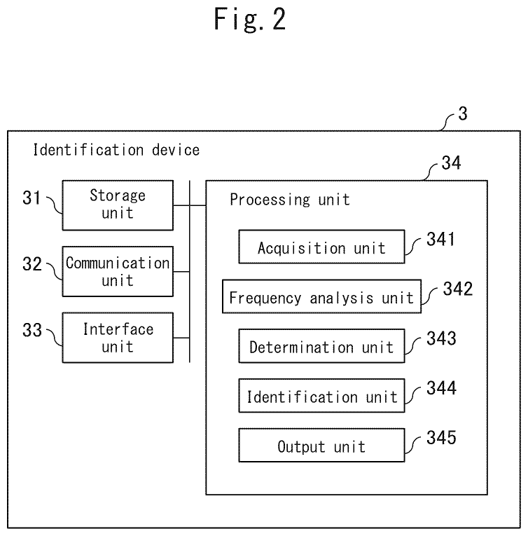

FIG. 2 is an exemplary functional block diagram of the identification device 3. The identification device 3 includes a storage unit 31, a communication unit 32, an interface unit 33, and a processing unit 34.

The storage unit 31 is configured to store data and programs, and includes, for example, a semiconductor memory. The storage unit 31 stores an operating system program, a driver program, an application program, and other data used for processing by the processing unit 34. The programs are installed in the storage unit 31 from a computer-readable and non-transitory portable storage medium, such as a compact disc read-only memory (CD-ROM) or a digital versatile disc read-only memory (DVD-ROM).

The communication unit 32 is configured to enable the identification device 3 to communicate with the monitoring terminal 4, and includes a communication interface circuit, which is, for example, a communication interface circuit for wireless local area network (LAN), wired LAN, or the like. The communication unit 32 transmits data provided from the processing unit 34 to the monitoring terminal 4.

The interface unit 33 is configured to receive input of information on vibration of the iron bars from the vibration sensor 2. The interface unit 33 includes a serial interface circuit, such as Recommended Standard 232 (RS-232) or Universal Serial Bus (USB). The interface unit 33 provides information inputted from the vibration sensor to the processing unit 34.

The vibration sensor 2 may transmit information on vibration of the iron bars to the identification device 3 via the communication unit 32. In this case, the identification device 3 need not include the interface unit 33.

The processing unit 34 is configured to control the overall operation of the identification device 3, and includes one or more processors and peripheral circuits. The processing unit 34 is achieved by circuitry and includes, for example, a central processing unit (CPU). The processing unit 34 may include a graphics processing unit (GPU), a large-scale integration (LSI), an application specific integrated circuit (ASIC), a field programmable gate array (FPGA), or the like. The processing unit 34 executes various processes based on the programs stored in the storage unit 31.

The processing unit 34 includes an acquisition unit 341, a frequency analysis unit 342, a determination unit 343, an identification unit 344, and an output unit 345 as functional blocks. Each of these units is a functional module achieved based on a program executed by the processing unit 34, or may be implemented in the identification device 3 as a dedicated operating circuit. The identification unit 344 is an example of the detection unit that detects whether the vibration is caused by hanging a string-shaped object.

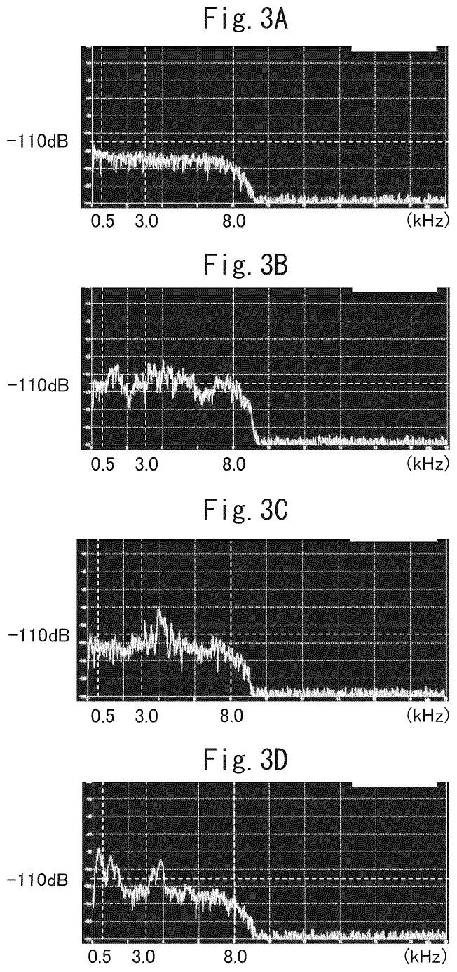

FIGS. 3A-3D are diagrams for explaining examples of vibration of iron bars. FIGS. 3A-3D show the spectra of vibration detected by the vibration sensor 2. In the examples shown in FIGS. 3A-3D, the components of the spectra above 8 kHz are removed by the conversion circuit included in the vibration sensor 2.

FIG. 3A shows the spectrum of vibration of iron bars that are not touched. As shown in FIG. 3A, when iron bars were not touched, the vibration spectrum did not exceed −110 dB in the range below 8 kHz and was generally flat.

FIG. 3B shows the spectrum of vibration of iron bars touched accidentally with a hand. As shown in FIG. 3B, when iron bars were touched accidentally with a hand, the spectrum showed multiple peaks exceeding −110 dB in the frequency band between 0.5 kHz and 8 kHz.

FIG. 3C shows the spectrum of vibration of iron bars around which a string-form towel is wrapped. As shown in FIG. 3C, when a string-form towel was wrapped around iron bars, the spectrum showed a peak exceeding −110 dB in the band above 3.0 kHz because of friction between the towel and the iron bars.

FIG. 3D shows the frequency components of vibration of iron bars for the case where a string-form towel is wrapped around the iron bars and body weight is placed on the towel. As shown in FIG. 3D, when a string-form towel was wrapped around iron bars and body weight was placed on the towel, the spectrum showed a peak exceeding −110 dB in the band above 3.0 kHz because of friction between the towel and the iron bars, as in FIG. 3C. The spectrum also showed a peak exceeding −110 dB in the band below 0.5 kHz because of low-frequency vibration caused by applying body weight. In the example shown in FIG. 3D, the spectrum also shows a peak in the band between 0.5 kHz and 3.0 kHz. This peak was probably caused by touching the iron bars when body weight was placed on the towel, and was not present continuously.

Although not shown in the figure, when iron bars were repeatedly touched with hands, the vibration spectrum showed a peak in the frequency band between 0.5 kHz and 3.0 kHz. Comparison with the example shown in FIG. 3B suggests that this is because repeated touches of hands prevent the transmission of vibration in the frequency band above 3.0 kHz. When iron bars were gripped and shook by hand, the vibration spectrum showed multiple peaks over the frequency band below 8.0 kHz.

In this way, when vibration of iron bars is caused by an inmate's action, the abnormal behavior causing the vibration can be identified based on whether frequency components exceed a reference value in the frequency bands below 0.5 kHz, between 0.5 kHz and 3.0 kHz, and above 3.0 kHz.

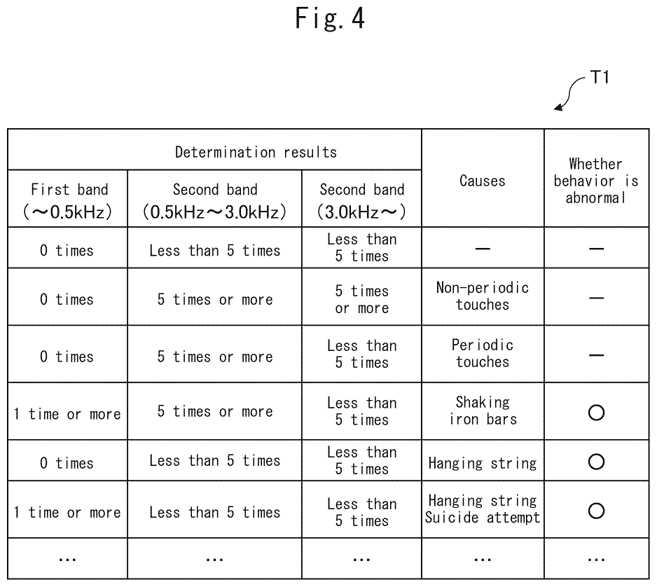

FIG. 4 shows an example of the data structure of a cause table T1 stored in the storage unit 31. The cause table T1 stores combinations of the results of determination whether the spectrum exceeds a reference value in the respective frequency bands and the causes of vibration of iron bars in association with each other.

In the example shown in FIG. 4, determination results are stored for a first band below 0.5 kHz, a second band between 0.5 kHz and 3.0 kHz, and a third band above 3.0 kHz. As the determination results, it is stored whether the number of times the spectrum of each band exceeds a predetermined reference value, among a predetermined number of determinations, is greater than or equal to a threshold. The predetermined number is, for example, 30 times. The predetermined reference value is, for example, −110 dB ( −110 dBSPL). The threshold for the first band is 1 time, and the threshold for the second and third bands is 5 times.

As shown in FIG. 3A, when iron bars are not touched, the vibration spectrum is generally flat. Thus, when the numbers of times the spectrum exceeds the reference value in the first, second, and third bands are less than the thresholds, it is determined that there is no vibration.

When the number of times the spectrum exceeds the reference value in the first band is less than the threshold and the numbers of times the spectrum exceeds the reference value in the second and third bands are greater than or equal to the threshold, the cause of the vibration is identified as non-periodic touches on the iron bars.

When the numbers of times the spectrum exceeds the reference value in the first and third bands are less than the thresholds and the number of times the spectrum exceeds the reference value in the second band is greater than or equal to the threshold, the cause of the vibration is identified as periodic touches on the iron bars.

As shown in FIG. 3B, when iron bars are being shaken, the vibration spectrum shows multiple peaks over a wide range. Thus, when the numbers of times the spectrum exceeds the reference value in the first, second, and third bands are greater than or equal to the thresholds, the cause of the vibration is identified as shaking the iron bars.

As shown in FIG. 3C, when a string-form towel is wrapped around iron bars, the vibration spectrum shows a peak in the high frequency range. Thus, when the numbers of times the spectrum exceeds the reference value in the first and second bands are less than the thresholds and the number of times the spectrum exceeds the reference value in the third band is greater than or equal to the threshold, the cause of the vibration is identified as hanging a string-form towel on the iron bars.

As shown in FIG. 3D, when a string-form towel is wrapped around iron bars and body weight is placed on the towel, the vibration spectrum shows peaks in both the low and high frequency ranges. Thus, when the number of times the spectrum exceeds the reference value in the second band is less than the threshold and the numbers of times the spectrum exceeds the reference value in the first and third bands are greater than or equal to the thresholds, the cause of the vibration is identified as hanging a string-form towel on the iron bars and placing body weight on the towel and as a suicide attempt. Since the frequency component in the second band may exceed the reference value by placing body weight on the towel as described above, the threshold for the second band is preferably set to a number of times greater than one. Thus, in the example shown in FIG. 4, the threshold for the second band is set to 5 times.

Shaking iron bars may indicate a high level of urgency within a correctional facility. Wrapping a string-form towel around an iron bar may be a preparatory act for a suicide attempt. Wrapping a string-form towel around an iron bar and placing body weight on the towel may be a suicide attempt. Thus, if the cause of the vibration is identified as one of these actions, it is determined that abnormal behavior has occurred.

The data of the cause table TI is preset and stored in the storage unit 31.

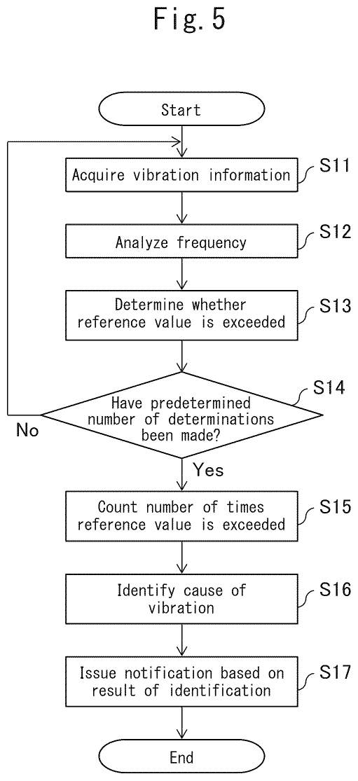

FIG. 5 is a flow diagram showing an example of the flow of the identification process executed by the identification device 3. The identification process is a process for identifying the cause of vibration of the iron bars. The identification process is periodically executed while the identification device 3 can acquire information on vibration from the vibration sensor 2. The identification process is achieved by the processing unit 34 cooperating with other components of the identification device 3, based on the storage unit 31.

First, the acquisition unit 341 acquires information on vibration of the iron bars from the vibration sensor 2 via the interface unit 33 (step S11). The acquisition unit 341 acquires a time-series digital signal indicating vibration of the iron bars during a predetermined determination period. The determination period is, for example, 100 milliseconds.

Next, the frequency analysis unit 342 executes frequency analysis on the information on vibration of the iron bars (step S12). For example, the frequency analysis unit 342 executes fast Fourier transform (FFT) processing on the time-series digital signal to generate a spectrum of frequency components.

Next, the determination unit 343 determines whether the frequency component of the detected vibration exceeds a predetermined reference value for each of frequency bands (step S13). The frequency bands are first, second, and third bands. For example, when at least one of the frequency components corresponding to the respective bands exceeds a reference value, the determination unit 343 determines that the frequency component of the vibration exceeds the reference value. The reference value is, for example, −110 dB. The determination unit 343 stores the determination result in the storage unit 31.

Next, the determination unit 343 determines whether a predetermined number of determinations have been made (step S14). The predetermined number is, for example, 30.

When a predetermined number of determinations have not been made (No in step S14), the identification process returns to step S101, and the acquisition unit 341 acquires a digital signal indicating vibration of the iron bars during the next determination period.

When a predetermined number of determinations have been made (Yes in step S14), the determination unit 343 counts the number of times the frequency component exceeds the reference value among the predetermined number of determinations for each of the frequency bands (step S15). The determination unit 343 acquires the results of the predetermined number of determinations from the storage unit 31 and counts the number of times the frequency component is determined to exceed the reference value.

Next, the identification unit 344 identifies the cause of the vibration of the iron bars, based on a combination of counting results for the frequency bands, thereby detecting whether the vibration is caused by hanging a towel on the iron bars (step S16). For example, the identification unit 344 identifies a cause corresponding to the combination of counting results in the cause table TI as the cause of the vibration. The identification unit 344 determines that the cause of the vibration is not hanging a towel on the iron bars, when the identified cause of the vibration is periodic or non-periodic touches on the iron bars or shaking the iron bars.

Next, the output unit 345 outputs a notification based on the result of identifying the cause of the vibration (step S17). For example, the output unit 345 outputs a notification with a level of urgency depending on the result of identifying the cause of the vibration. The output unit 345 generates notification data for causing the monitoring terminal 4 to output a voice for notification or to display an image for notification, based on the result of identifying the cause of the vibration. The output unit 345 outputs a notification by transmitting the notification data to the monitoring terminal 4 via the communication unit 32.

For example, when there is no vibration, the output unit 345 does not generate notification data. When the vibration is caused by non-periodic or periodic touches on the iron bars, the output unit 345 generates and transmits notification data with a low level of urgency to cause the monitoring terminal 4 to display an alert to a watcher. When the vibration is caused by shaking the iron bars or by wrapping a string-form towel, the output unit 345 generates and transmits notification data with a medium level of urgency to cause the monitoring terminal 4 to display an image and output a voice urging a watcher to check the area. When the vibration is caused by wrapping a string-form towel and placing body weight on the towel, the output unit 345 generates and transmits notification data with a high level of urgency to cause the monitoring terminal 4 to display an image and output a voice urging a watcher to immediately rush and check the situation. This completes the identification process.

As has been described above, the identification device 3 includes a determination unit 343 that determines whether a frequency component of the vibration of the iron bars satisfies a predetermined condition for each of frequency bands, and an identification unit 344 that identifies the cause of the vibration based on a combination of determination results for the frequency bands. In this way, the identification device 3 determines whether a frequency component of the vibration satisfies a predetermined condition for each of frequency bands, thereby enabling detecting an act of hanging a string-shaped object, based on the vibration.

The determination unit 343 determines whether the frequency component exceeds a reference value every determination period, and counts the number of times the frequency component exceeds the reference value; the identification unit 344 identifies the cause of the vibration, based on the counting results. In this way, the identification device 3 repeatedly determines whether the frequency component exceeds the reference value and counts the determination results, thereby preventing erroneous detection caused by accidental vibration and properly detecting an act of hanging a string-shaped object.

The frequency bands are a first band below 0.5 kHz, a second band between 0.5 kHz and 3.0 kHz, and a third band above 3.0 kHz; the identification unit 344 determines that the vibration is caused by a suicide attempt, when frequency components in the first and third bands exceed the reference value and a frequency component in the second band does not exceed the reference value. This enables the identification device 3 to detect a suicide attempt using an iron bar.

The identification device 3 may be modified as follows.

In the above embodiment, the determination unit 343 determines whether the frequency component exceeds the reference value in step S13 of the identification process. The invention is not limited to such an example; the determination unit 343 may determine whether a statistical value of the frequency component exceeds the reference value. The statistical value is, for example, an average, a median, or the like. In this way, the determination unit 343 may determine whether the frequency component satisfies a predetermined condition.

In the above embodiment, the determination unit 343 counts the number of times the frequency component exceeds the reference value every determination period in step S15 of the identification process, and the identification unit 344 identifies the cause of the vibration, based on the counting results in step S16. The invention is not limited to such an example; the determination unit 343 may determine time-varying changes in frequency components, and the identification unit 344 may identify the cause of the vibration, based on the time-varying changes in frequency components. For example, the identification unit 344 may identify the cause of the vibration, based on the number of times the frequency component exceeds the reference value consecutively. Even in this case, the identification device 3 can detect abnormal behavior, based on the vibration of the iron bars.

In the above embodiment, the identification unit 344 identifies the cause of the vibration, based on the preset cause table T1, in step S16 of the identification process. The invention is not limited to such an example; the identification unit 344 may identify the cause of the vibration, for example, using a trained model that has been trained to output the cause of vibration when the results of a predetermined number of determinations are inputted. The trained model is a neural network, a decision tree, or the like.

The above functions of the identification device 3 may be achieved by multiple vibration sensors and multiple devices. The functions of the identification device 3 may be activated only at specific times of day, such as at night, when suspects are more likely to make a suicide attempt.

It should be understood that those skilled in the art can make various changes, substitutions, and modifications without departing from the scope of the present invention. For example, the above embodiment and modified examples may be appropriately combined and implemented within the scope of the present invention.

1. An identification device comprising a processor configured to:
acquire information on vibration of a catching part from which a string-shaped object can be suspended,
determine, for each of frequency bands, whether a frequency component of the vibration in the frequency band satisfies a predetermined condition,
detect whether the vibration is caused by hanging the string-shaped object on the catching part, based on a combination of determination results for the frequency bands, and
output a notification based on the result of detection of the cause of the vibration.

2. The identification device according to claim 1, wherein the processor is configured to:
determine whether frequency components of the vibration in the respective frequency bands exceed a predetermined reference value every predetermined determination period, and counts the number of times the frequency component exceeds the reference value for each frequency band, and
detect whether the vibration is caused by hanging the string-shaped object on the catching part, based on a combination of counting results for the frequency bands.

3. The identification device according to claim 1, wherein the frequency bands are a first band below 0.5 kHz, a second band between 0.5 kHz and 3.0 kHz, and a third band above 3.0 kHz.

4. The identification device according to claim 3, wherein the processor is configured to determine that the vibration is caused by a suicide attempt, when frequency components in the first and third bands exceed a reference value and a frequency component in the second band does not exceed the reference value.

5. An identification method executed by an identification device, the identification method comprising:
acquiring information on vibration of a catching part from which a string-shaped object can be suspended;
determining, for each of frequency bands, whether a frequency component of the vibration in the frequency band satisfies a predetermined condition;
detecting whether the vibration is caused by hanging the string-shaped object on the catching part, based on a combination of determination results for the frequency bands; and
outputting a notification based on the result of detection of the cause of the vibration.

6. A computer-readable non-transitory storage media storing a program causing a computer to execute a process comprising:
acquiring information on vibration of a catching part from which a string-shaped object can be suspended;
determining, for each of frequency bands, whether a frequency component of the vibration in the frequency band satisfies a predetermined condition;
detecting whether the vibration is caused by hanging the string-shaped object on the catching part, based on a combination of determination results for the frequency bands; and
outputting a notification based on the result of detection of the cause of the vibration.
